(19) United States
(12) Patent Application Publication
(10) Pub. No.: US 2015/0109206 A1
(43) Pub. Date: Apr. 23, 2015

(54) REMOTE INTERACTION SYSTEM AND CONTROL THEREOF

(71) Applicant: HIHEX LIMITED, Hong Kong (CN)

(72) Inventor: Zhipei Wang, Hong Kong (CN)

(21) Appl. No.: 14/395,433

(22) PCT Filed: Apr. 19, 2013
(86) PCT No.: PCT/CN2013/074431

§ 371 Date: Oct. 17, 2014

(30) Foreign Application Priority Data
Apr. 20, 2012 (HK) 12103952.6

(51) Int. Cl. G06F 3/0346; G06F 3/0482; G06F 3/0484; G06F 3/023

(52) U.S. Cl. CPC G06F 3/0346; G06F 3/0236; G06F 3/0482; G06F 3/04842
USPC 345/158

(57) ABSTRACT

A system, method and process for interactions between user and an display is described.

In one embodiment, the user selects input parameters displayed on a remote visual display device, the input parameters being represented by indicia spaced apart from a base indicia. The system includes a motion detector for detecting motion indicative of the spatial relationship between the base indicia and other indicia.

The detected motion is used to select a first input parameter and a further input parameter is selected upon detection of a further motion of the device indicative of the spatial relationship between the base indicia and a further indicia indicative of said further input parameter.

### TECHNICAL FIELD

The present invention relates generally to remote control systems for operation of a device; and more specifically to a device, method and system for operation of a large screen display device.

### BACKGROUND

User interaction with the increasing number of electronic devices is commonly mediated through the selection of the appropriate remote control device, followed by selecting a desired operation from an array of buttons or options present on such remote control.

Such user interactions are typically an adaptation from conventional keyboard and mouse style interaction with electronic devices and often require either selection or navigation by or with a cursor using arrow style keypads. Such remote controls may be used to select from options displayed on screen of the remote control device or on a display screen.

User interaction with an electronic display device using such remote controls is laborious and counter intuitive, often requiring repeated operation or selection of navigation buttons in order to modify a desired parameter such as volume or choose from a range of options to activate a selected control. Repeated visual adjustment by a user is required from near field vision of the remote control to the cursor which may be displayed on a display screen at some distance from the user.

Such user interaction represents a significant impediment to an immersive user experience.

As an alternative to the conventional mechanism of interaction using a remote control device, there have been proposed a number of remote control devices which detect motion of the remote control device in three dimensional space such as the Microsoft® XBox Kinect. Such devices may use gyroscopic or accelerometer based remote controls or camera based motion sensors.

Such movement based remote controls typically require detailed sampling of motion path, in order to determine direction and distance information, which in turn requires intensive computational processing to determine the motion path taken by the remote control device. Typically, the increased data and associated processing required for operation of these prior art devices leads to delayed responsiveness and errors in processing.

### SUMMARY

Accordingly, it is an object of the present invention to provide a remote interaction system and control thereof which overcomes or at least ameliorates some of the deficiencies exhibited by the prior art.

In a first aspect, the present invention provides system for providing interactions between a processor and an input device by a user for selection of one or more input parameters. The system comprises a remote visual display device for displaying a base indicia and a first plurality of indicia spaced apart from the base indicia, wherein said base indicia and said first plurality of indicia are remotely visually identifiable by a user and wherein each of said indicia being indicative of an input parameter; and a user operable selection and input device for remote user selection of an input parameter, said device including a motion detector for detecting motion of the device indicative of the spatial relationship between the base indicia and an indicia of the first plurality of indicia. A first input parameter is selected upon detection of a first motion of the device indicative of the spatial relationship between the base indicia and a first indicia indicative of said first input parameter, and a further input parameter is selected upon detection of a further motion of the device indicative of the spatial relationship between the base indicia and a further indicia indicative of said further input parameter.

The motion indicative of the spatial relationship between the base indicia and the indicia associated with the remotely selectable input parameters may be displacement, rotation, or combinations thereof.

The motion indicative of the spatial relationship between the base indicia and the indicia associated with the remotely selectable input parameters is a displacement in a direction indicative of the spatial relationship of said indicia associated with the remotely selectable input parameters relative to the base indicia.

Upon detection of said motion by said motion detector, a remotely selectable input parameter may be selected. The selection of the first remotely selectable input parameter may be confirmed by a pre-defined completion action by the user. The completion action of the user may be selected from the group including activation of a user operable switch of the device, motion of the device in a predetermined direction, motion of the device at a predetermined speed, motion the device at a predetermined acceleration or the like.

The detection of the motion of the device is initiated upon a pre-determined initiation action by a user. The detection of the motion of the device for selection of an input parameter may be initiated upon activation of a switch of the device and wherein detection of the motion of the device for selection of the input parameter terminates upon detection of a pre-defined completion action.

In an embodiment of the present aspect of the invention, the first plurality of indicia may arranged at least partly circumferentially about the base indicia or arranged in a circumferential arrangement about the base indicia. The first plurality of indicia may extend from the perimeter of the base indicia. Preferably, the indicia are selected from the group of shapes including squares, pentagons, hexagons, octagons and the like.

In an embodiment of the present aspect of the invention, upon user selection of one of the first plurality of indicia, a second plurality of indicia indicative of further input parameters is displayed. The second plurality of indicia displayed may be in a pre-determined relationship with the selected indicia of the first plurality of indicia.

The pre-determined relationship is selected from a group which includes alphabetical proximity, or spatial proximity on a keyboard, alpha numeric grouping, or the like.

In a preferred embodiment of the present aspect of the invention, the device is a hand held remote control device.

The motion detector is a gyroscopic sensor configured to produce a signal in response to angular motion relative to one or more reference axes, of the sensor.

The hand held remote control device may include a motion detector configured to detect one or more parameters selected from the group including linear acceleration, angular acceleration, velocity, displacement or the like.

Upon selection of a remotely selectable input parameter a change in one or more visual properties of the indicia corresponding to the selected input parameter may be displayed on the display device. Upon selection of a remotely selectable input parameter, at least one of an audio signal, visual signal or tactile signal is emitted from the user operable selection and input device.

In a second aspect, the present invention provides a device for selection of one or more input parameters and for providing interaction between a user and a processor of a system including a remote visual display device for displaying a base indicia and a first plurality of indicia spaced apart from the base indicia, wherein said base indicia and said first plurality of indicia are remotely visually identifiable by a user and wherein each of said indicia being indicative of an input parameter, said device including a motion detector for detecting motion of the device indicative of the spatial relationship between the base indicia and an indicia of the first plurality of indicia, wherein a first input parameter is selected upon detection of a first motion of the device indicative of the spatial relationship between the base indicia and a first indicia indicative of said first input parameter, and a further input parameter is selected upon detection of a further motion of the device indicative of the spatial relationship between the base indicia and a further indicia indicative of said further input parameter.

In an embodiment of the second aspect, the device is a hand held remote control device. The motion detector may be a gyroscopic sensor configured to produce a signal in response to angular motion relative to one or more reference axes, of the sensor.

The hand held remote control device preferably includes a motion detector configured to detect one or more parameters selected from the group including linear acceleration, angular acceleration, velocity, displacement or the like.

Upon selection of a remotely selectable input parameter a change in one or more visual properties of the indicia corresponding to the selected input parameter is displayed on the display device.

Upon selection of a remotely selectable input parameter, at least one of an audio signal, visual signal or tactile signal is emitted from the user operable selection and input device.

In a third aspect, the present invention provides a system for providing interactions between a processor and a user for selection of one or more input parameters, wherein the input parameters are represented by base position and a first plurality of positions spaced apart from the base position, and wherein the positions are indicative of input parameters, said system comprising a user operable selection and input device for remote user selection of an input parameter, said device including a motion detector for detecting motion of the device indicative of the spatial relationship between the base indicia and an indicia of the first plurality of indicia, wherein a first input parameter is selected upon detection of a first motion by the user indicative of the spatial relationship between the base position and first position of said first input parameter, and a further input parameter is selected upon detection of a further motion by the user indicative of the spatial relationship between the base position and a further position indicative of said further input parameter.

The user operable selection and input device may be a hand held device.

Alternatively, the user operable selection and input device is a remote motion detection device for detecting motion of the user, such as an optical image acquisition system.

In an embodiment of the third aspect, there is further included a remote visual display device for displaying a base indicia indicative of said base position, and a first plurality of indicia spaced apart from the base indicia indicative of said first plurality of positions spaced apart from the base position, wherein said base indicia and said first plurality of indicia are remotely visually identifiable by a user and wherein each of said indicia being indicative of an input parameter.

In a further aspect, the present invention provides a method of providing selection of one or more input parameters by interactions between a processor and an input device by a user in a system comprising a remote visual display device for displaying a base indicia and a first plurality of indicia spaced apart from the base indicia, wherein said base indicia and said first plurality of indicia are remotely visually identifiable by a user and wherein each of said indicia being indicative of an input parameter; and a user operable selection and input device for remote user selection of an input parameter, said device including a motion detector for detecting motion of the device indicative of the spatial relationship between the base indicia and an indicia of the first plurality of indicia said method including the steps of (i) selecting a first input parameter by selecting a first indicia of the first plurality of indicia displayed in the visual display device; and (ii) selecting a further input parameter by selecting a further indicia of the first plurality of indicia displayed in the visual display device; wherein the first indicia is selected by motion of the device by a user indicative of the spatial relationship between the base indicia and the first indicia indicative of said first input parameter, and wherein the further indicia is selected by motion of the device by a user indicative of the spatial relationship between the base indicia and the further indicia indicative of said further input parameter.

In another aspect, the present invention provides a method of providing selection of one or more input parameters by interactions between a processor and a user of a system for selection of one or more input parameters, wherein the input parameters are represented by base position and a first plurality of positions spaced apart from the base position, and wherein the positions are indicative of input parameters, wherein the system comprises a user operable selection and input device for remote user selection of an input parameter, said device including a motion detector for detecting motion of the device indicative of the spatial relationship between the base indicia and an indicia of the first plurality of indicia, said method including the steps of: (i) selecting a first input parameter by movement of a user in a direction of from the base position towards a first position of the first plurality of positions, wherein said movement is detected by said motion detector; and (ii) selecting a further input parameter parameters by movement of the user in a direction of from the base position towards a further position of the first plurality of positions, wherein said movement is detected by said motion detector, wherein the first position is selected by motion of the device by a user indicative of the spatial relationship between the base position and the first position indicative of said first input parameter, and wherein the further position is selected by motion of the user indicative of the spatial relationship between the base position and the further position is a indicative of said further input parameter.

### BRIEF DESCRIPTION OF DRAWINGS

Preferred embodiments of the present invention will be explained in further detail below by way of examples and with reference to the accompanying drawings, in which:

FIG. 1 shows an exemplary schematic exemplary schematic diagram of a system for remote control interaction.

FIG. 2 shows a schematic diagram of an embodiment of the system for interaction with an electronic device including a display.

FIG. 3 shows an exemplary remote control device according to an embodiment of the present invention.

FIG. 4 shows a schematic representation of the displayed information on an exemplary device when used together with the exemplary device of FIG. 3.

FIG. 5A-FIG. 5E shows an exemplary interaction upon the system depicted in FIG. 3.

FIG. 6A and FIG. 6B show a further exemplary interaction which may take place in the system depicted in FIG. 1 wherein the system is used for inputting of user text.

FIG. 7A and FIG. 7B shows an exemplary grouping for text entry which may be utilised when using the arrangement shown in FIG. 6A.

FIG. 7C and FIG. 7D show an exemplary grouping for text entry which may be utilised when using the arrangement shown in FIG. 6B.

FIG. 8 shows an alternative embodiment wherein of the present invention wherein the keyboard is arranged in a QWERTY input arrangement with a nested second level input.

FIG. 9 shows an alternative embodiment where the displayed user parameters of the overall array are only partly shown.

FIG. 10 shows yet a further embodiment of the present invention where the system is configured to react to movement of the user's hand.

FIG. 11 shows further alternative geometric configurations of the user elements.

### DETAILED DESCRIPTION

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

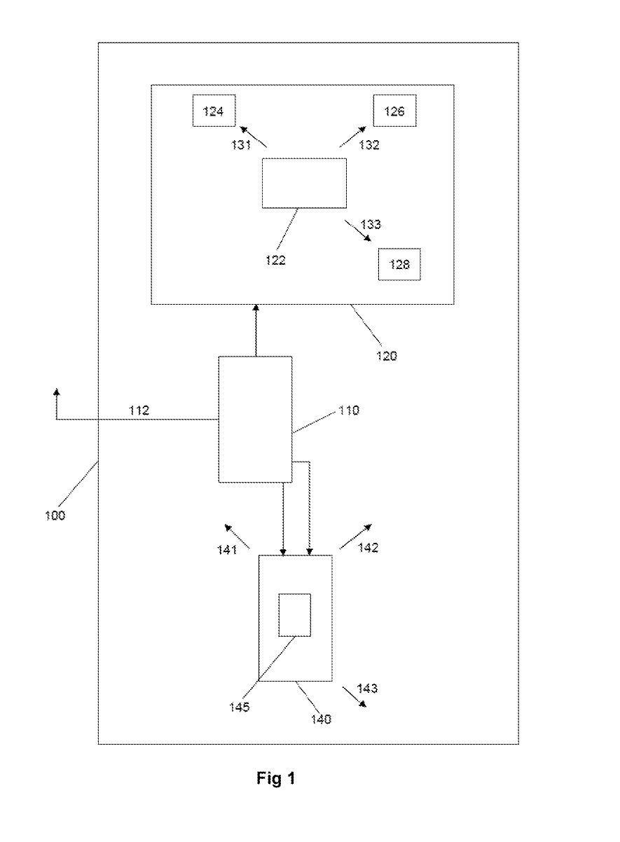

Referring to FIG. 1, there is shown an exemplary schematic diagram of a system 100 according to the present invention. The system 100 provides for interaction between a processor 110 for performing functions from user selected input parameters. An input device 140 which is operable by a user provides for selection of one or more input parameters.

The system 100 comprises a remote visual display device 120 for displaying a base indicia 122 and a first plurality of an indicia 124, 126, 128 spaced apart from the base indicia 122. The base indicia 122 and the first plurality of indicia 124, 126, 128 are displayed on the visual display device so that a user may remotely identify such indicia. The indicia are indicative of an input parameter which the processor 110 performs once selected by the user.

The system 100 further includes a user operable selection and input device 140 which provides for the user to remotely select an input parameter. The device 140 includes a motion detector 145 for detecting motion of the device 140, whereby the motion is indicative of the spatial relationship between the base indicia 122 and indicia of the first plurality of indicia 124, 126, 128.

A first input parameter is selected when a user moves the device 140 in a first direction 141 which is indicative of the spatial relationship between the base indicia 122 and a first indicia 124, as shown by arrows 141 corresponding with the motion in the direction of arrow 131.

A user may then select a further input parameter by moving the device 140 in a direction indicative of a further input parameter as associated with a further indicia 126, as depicted by motion of the device 140 in a direction 142 corresponding to the spatial relationship of the further indicia 126 from the base indicia 122 as shown by corresponding arrow 132.

Similarly, yet further selections may be made by a user by moving the device 140 in the direction 143 which corresponds with the spatial relationship of the yet further indicia 128 as disposed from the base indicia 122 as shown by arrow 133.

As will be understood, the selection of an input parameter is based on the relative motion of the device 140 with respect to the represented spatial relationship of a selection indicia with respect to a base indicia 122 as shown on the visual display device. Irrespective of where the device 140 is in three-dimensional space, the fact to movement of the device 140 as corresponding to the spatial disposition between further indicia and the base indicia 122 are upon which selection of such further input parameters are based. A person skilled in the art will appreciate that the movement of device may also be only in two dimensional space, such as movement on a desktop.

Accordingly, irrespective of the position of the device 140 after selection of a first indicia, a further indicia is selected by vectorial motion corresponding to the disposition of indicia as correlating with a requisite input parameter.

The motion of device 140 for selection of indicia may be displacement, rotation, or alternatively combinations thereof.

Those skilled in the art will appreciate that upon completion of a motion in a direction towards a requisite indicia relating to a required input parameter, confirmation of a pre-defined action by a user for selection of a requisite input parameter may be provided in various manners, without departing from the scope of the invention.

In an embodiment of the invention, completion of an action may be determined by a further motion of the device 140 other than that in the direction of an indicia.

Alternatively, completion of the action by a user may include activation of a user operable switch, motion of the device in a pre-determined direction, motion of the device at a pre-determined speed, motion of the device at a pre-determined acceleration or the like, or combinations thereof.

Further, detection of commencement of motion of the device 140 may be initiated by a pre-determined initiation action by the user such as activation of the switch or a particular detectable motion of the device 140.

As shown in FIG. 1, the first plurality of indicia 124, 126, 128 are arranged in a spaced apart and partially circumferential relationship with reference to the base indicia 122. Accordingly, motion in a direction towards one of the plurality of indicia 124, 126, 128 from the base indicia 122 may be cognitively determinable by a user such that the motion coincides with the vectorial spatial disposition of an indicia of the plurality of indicia 124, 126, 128.

In other or alternate embodiments, the plurality of the indicia 124, 126, 128 may extend circumferentially around the base indicia, and may be equally spaced apart from each other.

Further, the plurality of indicia may be contiguous or extending from the parameter of a base indicia. The geometry and shape of the indicia may be selected from a group including squares, pentagons, hexagons, octagons or the like.

Those skilled in the art will appreciate that the spatial relationship and number of indicia will affect the cognitive process of a user in relative motion so as to select indicia, and depending upon the resolution of the visual display device as well as the resolution and detection quality of the movement of the device 140.

In other embodiments, selection of one of the first plurality of indicia may activate a second plurality of indicia which are indicative of further input parameters, and these may be displayed on the visual display device 120 accordingly. The display of the second plurality of indicia may be displayed in a pre-determined relationship with the first plurality of indicia, based on cognitive function, standards, ease of interpretation or the like, for example, a pre-determined relationship may be that of alphabetical proximity, spatial proximity on a keyboard, alphanumeric grouping, grouping and cognitive selection in the language of use or the like.

The indicia 124, 126, 128 as displayed on the visual display device 120 may be highlighted upon sufficient selection so as to enhance cognitive spatial perception by a user when using the device and selecting important parameters. Selection of an input parameter may be indicated by feedback to a user, such as an audio signal, visual signal, tactile signal emitted from the device 140 or the like.

The motion detector 145 of the device 140 may be a motion detector 145 configured to detect one or more spatial movement parameters including linear acceleration, angular acceleration, velocity, displacement or the like.

The processor 110 may be in communication with the device 140 by way of wireless communication, such as radio frequency transmission, infrared or optical communication, Bluetooth type communication or the like.

The processor 110 may be in communication with the visual display device 120 by way of wired connection. Alternatively, those skilled in the art will appreciate that the communication between the processor 110 and the visual display device 120 may be way of wireless communication.

Further, as will be appreciated by those skilled in the art, the processor then may be incorporated within the device 120.

Upon selection of a requisite input parameter, the processor may provide an output signal 112 to a further device external of the system 100, depending upon the application of the system 110.

Those skilled in the art will understand that in other or alternate embodiments of the system 100, display indicia may not be necessary if a standard protocol is known by a user. Further, those skilled in the art will appreciate that motion may be detected by a user by alternate methods such as an external optical in each acquisition system, capable of ascertaining movements and directions of motion of a user, and thus allow a user to select indicia and hence activate requisite input parameters without physical contact with a device 140.

Those skilled in the art will appreciate that the present invention provides for ease of cognitive identification of input parameters and selection thereof based upon an indicia which, upon detection of an appropriate vectorial movement by a user corresponding to a spatial displacement of a corresponding indicia to a base indicia, allows ease of selection.

Furthermore, irrespective of the location of the device 140, the movement of the device 140 in a direction corresponding to that of the vectorial displacement of an indicia with respect to a base indicia provides for ease of input and selection by a user.

Still further, those skilled in the art will appreciate that a lower amount of computational power is required, as motion of the device 140 need only be determined upon activation of the device for commencement of a movement indicative of selection of a indicia and hence input parameter, thus simplifying a process of selection of subsequent indicia for subsequent input parameter selection.

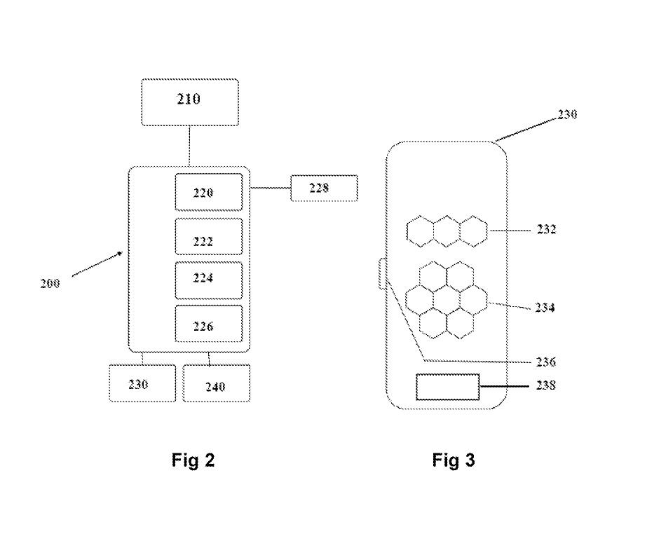

Referring to FIG. 2, there is shown a further exemplary embodiment of type of system 200 according to the present invention. It is appreciated by persons skilled in the art that there are many alternative or additional configurations of the components displayed, or which perform similar functions.

As shown in FIG. 2, there is included a display 210, which may be a large screen display such as a television, computer monitor, projection screen or similar. A remote processing unit 218 includes a processor 220 and may be located in electrical communication with the display 210 may be either physically independent of or integrated with the display 210.

The processor 220 is in turn in electrical communication with memory storage devices 222,224 such as a CD ROM, Hard Disk Drive, SD Card Reader EEPROM or other form of electronic storage medium upon which processor instructions and content for display may be stored in memory. The processor 220 may also be arranged to receive information from a signal processor 226, and from external content sources and input information 228 such as internet, cable, satellite and terrestrial television or movie stations for processing and display upon the display 210.

In communication with the processor 220 via the signal processor 226, a remote control device 230 transmits signals from the remote to the processor 220 using wireless, infrared or RF waves As will known in the art. The signal processor 228 may include well-known circuitry for performing necessary functions, including but, an RF transceiver, one or more amplifiers, a tuner, one or more oscillators, a digital signal processor, a CODEC chipset, memory, and so forth.

Optionally there may also be located a camera device 240 in electrical communication with the processor 220 for capturing images of a user located remotely of the display 210.

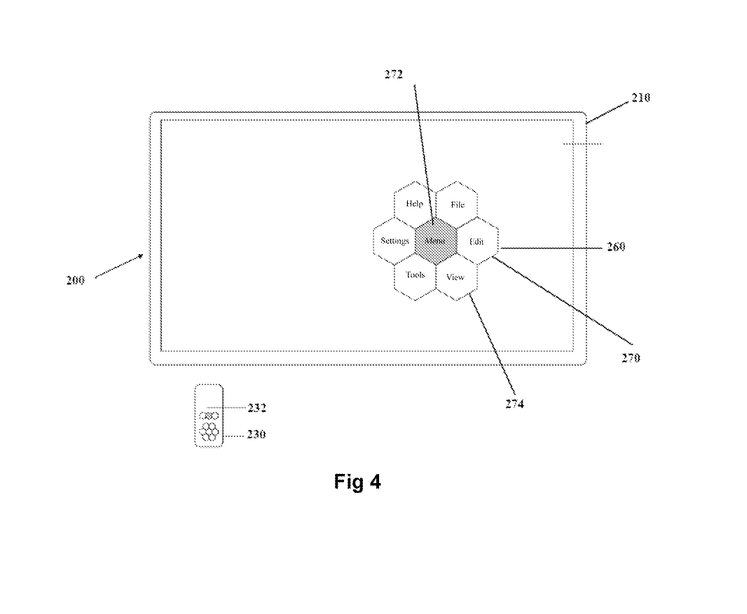

Referring to FIG. 3, in a preferred embodiment, the device 230 may be a hand held remote control device which is in communication with the display 210 through transmitted signals.

As will understood by a person skilled in the art, a variety of possible configurations and alternatives of the remote control device would be possible, including different arrangements and orientations of various buttons and/or keys.

The hand held remote control device may include control keys 232 which are used to issue control signals to the display 210, together with or in addition or alternative to an input keyboard 234 which may be used to provide to the processor signals indicative of various letters.

It would be appreciated by a person skilled in the art that the control keys may include video playback, menu commands, special functions such as channel selection.

The input keys may be designed to input conventional western keyboard characters such as A-Z keys; numbers, symbols, formatting commands (such as new line or backspace, delete) and characters or words in other languages including Chinese and Japanese.

It will be appreciate that the control keys and the input keys may or may not be separated from each other, depending upon the user configuration desired. It will be appreciated that depending upon the mode of operation of the remote control device, the same key may function as either a control key or an input key.

The hand held remote device may also include one or more switch buttons 236 located on the side of or underneath the device. These switch buttons 236 may be used to actuate transmission of a signals indicative of motion from the remote control device 230, such motion being detected by a motion detector 238 which is included within the remote control device.

As will appreciated by persons skilled in the art, such a motion detector may be a single or multiple axis gyroscopic device, accelerometer or similar device arranged to detect motion of the remote control device throughout three dimensional space by a user. If a gyroscopic sensor is used, it may be configured to produce a signal in response to angular motion relative to one or more reference axes, of the sensor. Alternatively, the motion detector device may be used to detect one or more parameters selected from the group including linear acceleration, angular acceleration, velocity, displacement or the like.

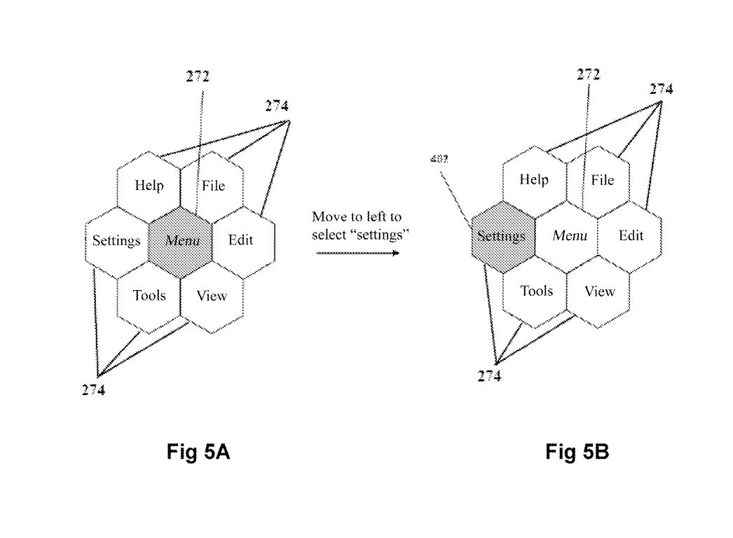

Referring to FIG. 4, there is shown an exemplary operation of the system 200, in which a control key 232 of the remote control device 230 has been depressed. Actuation of the control key 232 by a user causes the display 210 to show the on screen menu 260, including various indicia or representations 270. The on screen indicia shown are displayed in an exemplary arrangement, and represent various commands which may be issued by the user to the processor 220 using the remote control device 230.

The present invention may permit a processor tracking the location of the remote controlled device to be activated only upon issuance of a command type motion from the user of the remote controlled device. This means that the processor does not have to continuously track the position of the remote controlled device in three dimensional space.

It will be appreciated by a person skilled in the art, that the indicia may be displayed in a variety of arrangements, and may include graphical representations (not shown) alone or in conjunction with text labels which are depicted.

As shown, the indicia displayed include a base indicia 272 about which a number of other indicia representations are displayed 274, and which correspond to commands which may be issued by the remote control device 230 to the processor 220.

By default the display of the on screen menu starts with the active indicia being displayed at the base position, and corresponding to the position of the remote control device in three dimensional real space before being moved by the user. The active indicia may be made visually distinct to the user, including by changing colour, shading (as shown) or by enlarging the text and/or background of the base indicia or other similar techniques As will known to persons skilled in the art.

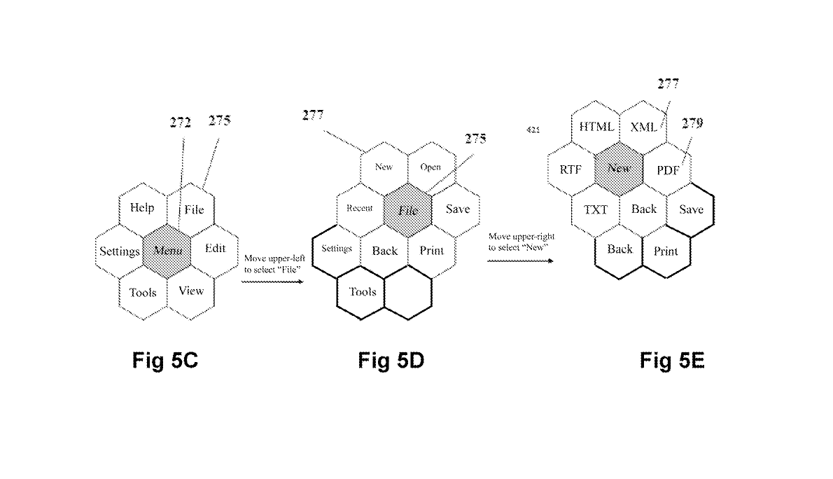

Once the on screen display is activated by a user, the remote control device 230 may be used by the user to select a command to be performed by the processor as shown by FIGS. 5A-5E. The active indicia 272 is shown in FIGS. 5A-5E, and a plurality of other indicia 274 corresponding to other associated commands are also displayed in an exemplary configuration about the base indicia.

As shown on the display, the “Settings” indicia is located to the left of the “Menu” indicia; while the “File” indicia is located diagonally up and to the right relative to the base indicia.

By actuation of the switch button 236 of the remote control device 230, the processor is configured to begin capture of position information of the device in three dimensional space.

In order to issue the “Settings” command to the processor, in the exemplary embodiment the user moves the remote control device to the left; to select the indicia corresponding to “Setting” and make that the active indicia. Since the direction of the indicia relative to the base position is left, the user moves the device to the left to change the active indicia.

Upon the active indicia of the display changing to “Setting” in accordance with the user's motion of the device in three dimensional space, the user may release the switch button of the remote control thereby causing the settings command to be issued to the processor by the remote control device.

Confirmation that a command has been issued to the processor by the remote control device may be provided by an audio signal, visual signal or tactile signal is emitted from the user operable selection and input device. Alternatively, confirmation may be provided by a change in one or more visual properties of the indicia corresponding to the selected input parameter is displayed on the display device.

A person skilled in the art will appreciate that the motion of the device in three dimensional space may be displacement in a direction of the other indicia relative to the base indicia, in this case moving to the left which is detected by the motion detector of the remote control device. One or motion detectors may be used in the remote control device in accordance with user requirements/desired operation techniques and sensitivity.

Alternatively, it will be appreciated by a person skilled in the art that rotation or acceleration may be another parameter detected by the remote control device in directions indicative of the spatial relationship of the displayed indicia relative to the base indicia.

Similarly a person skilled in the art will appreciate that the position information of the device in three dimensional space may be captured once a switch is actuated, if the device is moved in a certain direction, or once a certain threshold of displacement, acceleration or other parameter which can be detected by the motion detector of the remote control device is exceeded. An appropriate action for ceasing the capture of such position information may also include further actuation of a switch, or through exceeding a further such parameter detected by the motion detector of the remote control device.

It will be appreciated that advantageously in an embodiment of the present invention, the change in positional information in three dimensional space may be utilised to select an appropriate option upon the directional data exceeding a certain predetermined threshold.

Referring to FIGS. 5C-5D, a number of levels for commands may be achieved, through “nesting” of the criteria as shown in the Figure. A first level selection may be made by the user, in a manner similar to that described above in relation to FIGS. 5A-5B of the “FILE” menu.

Upon release of the switch by the user, or performance of some other completion action, a further on screen menu may be displayed as shown in FIG. 5D, with various options shown in a spatial arrangement about the FILE menu. These options may be dynamically assigned by the system and shown upon the display or alternatively may be control functions which are continuously present.

The base indicia 275 shown in FIG. 5D is now the “File” selection, which has a further alternative indicia such as “NEW” 277 located diagonally upwards and to the left of the file selection. Upon further actuation of the switch, the user may move the remote control device towards the upper diagonal left position in three dimensional space, release the switch to issue the “NEW” command to the processor.

Issuance of the “NEW” command to the processor in turn is used to generate the on screen menu displayed in FIG. 5E, in which the base indicia 277 is the NEW command and a variety of indicia 279 are arranged to provide options about the base indicia as shown.

Accordingly, as will be appreciated by a person skilled in the art, a “nested” menu style of commands could be created, with each successive on screen display dynamically generating a variety of options for selection based upon the previous menu selection, each of these options displayed on indicia arranged about the base indicia in a pre-determined spatial arrangement.

It will be appreciated by a person skilled in the art that the selection of displayed indicia, rather than presentation of a cursor in the described embodiment of the present invention means that user is not required to determine the position of any cursor on the display screen. Furthermore, because there is no cursor which is displayed on the screen, there is therefore no requirement for controlling a cursor on the screen using directional buttons on the remote control device, as is the case in certain prior art controllers. A person skilled in the art would appreciate that this provides ease in operation; as the user no longer has to refocus on near field remote control object and a potentially distant screen. Instead, a natural and inituitive directional movement can be used to choose a selected indicia.

Upon activation of the motion detection functions of the controller, once movement and selection in three dimensional space in a direction corresponding to the spatial arrangement of the indicia has taken place and a selection has been made by the user, the corresponding on screen display may be shown/command made As will required.

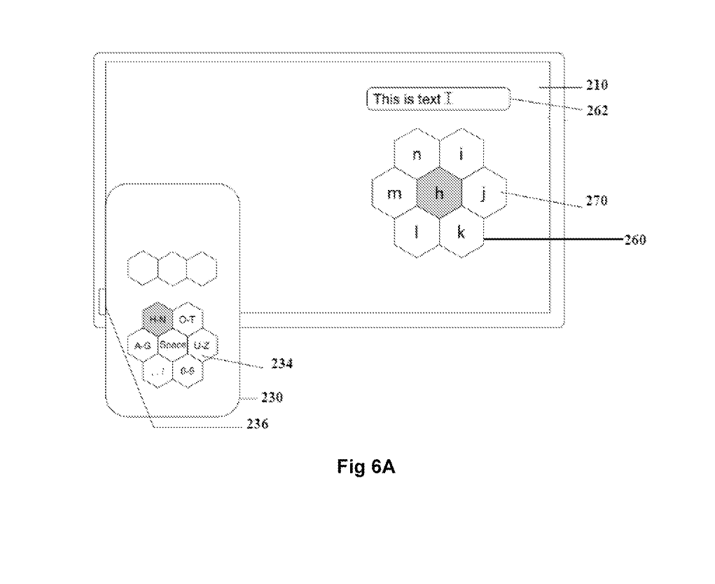

As shown in FIG. 6A, FIG. 6B, two further illustrative embodiments of the present invention show an arrangement wherein movement in three dimensional space corresponding to the orientation of on screen indicia may be used to input text.

The keyboard buttons of the remote control 234 may be used to select one or more base indicia, with the process of selection of the second level text entry proceeding as previously described through movement of the remote control device. The groupings of the text at the top level may be arranged alphabetically, as shown in FIG. 6A or as arranged on the keyboard, as shown in FIG. 6B. Capitalisation may be effected using the switch key.

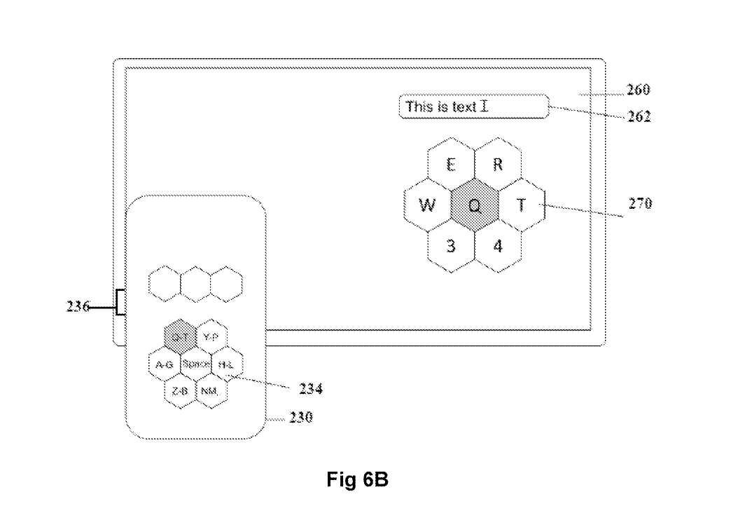

FIGS. 7A and 7B show exemplary text groupings corresponding to the keyboard layout depicted in FIG. 6A, with the top level selection shown, together with underlying second level text entries for selection using the movement of the remote control device as previously described.

FIG. 7C and FIG. 7D show exemplary text groupings corresponding to the keyboard layout depicted in FIG. 6B, with the top level selection shown, together with underlying second level text entries for selection using the movement of the remote control device as previously described. It will be appreciated by a person skilled in the art that other groupings such as alphabetical proximity, or spatial proximity on a keyboard, alpha numeric grouping, or the like could be utilised.

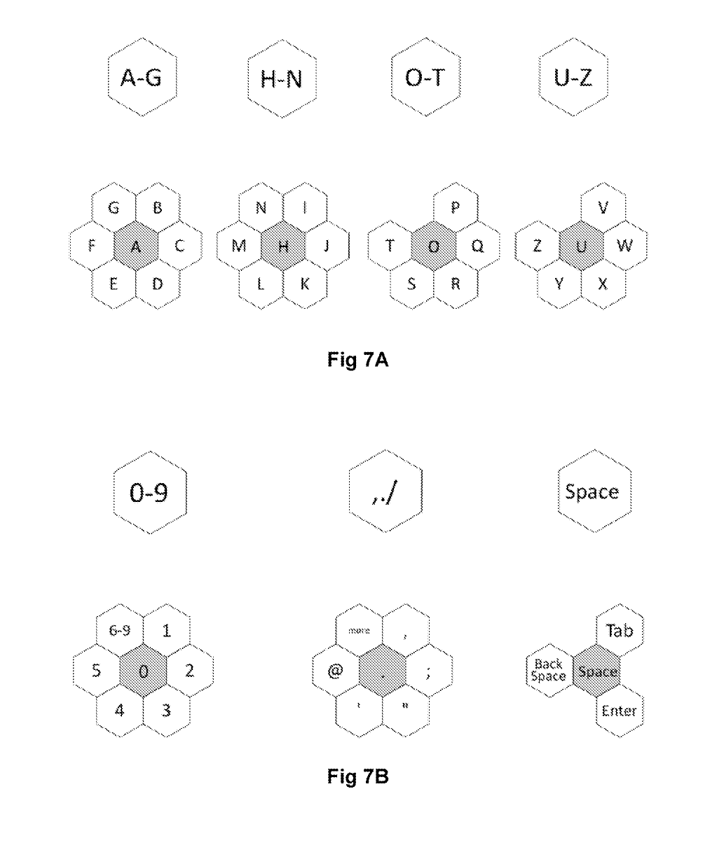

FIG. 8 shows an embodiment of the present invention wherein the keyboard keys 234 of the remote control device are configured so as to provide one key level input. When the QWERTY input key 235 is selected, the on screen display shows the arrangement of indicia as shown in the groupings of FIGS. 7A and 7B. A user is then able to select the entry based upon movement of the remote control device in a direction as discussed above.

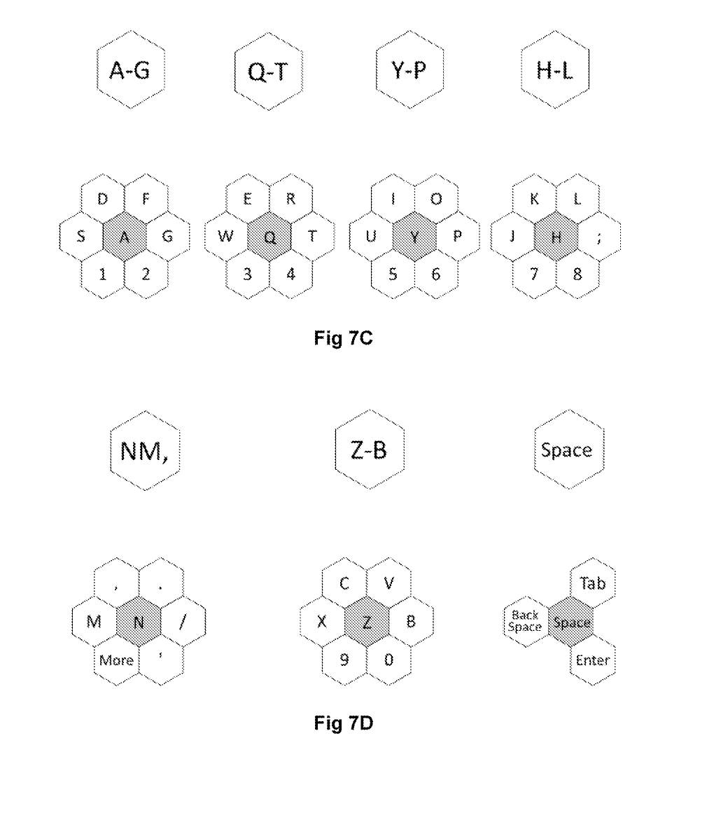

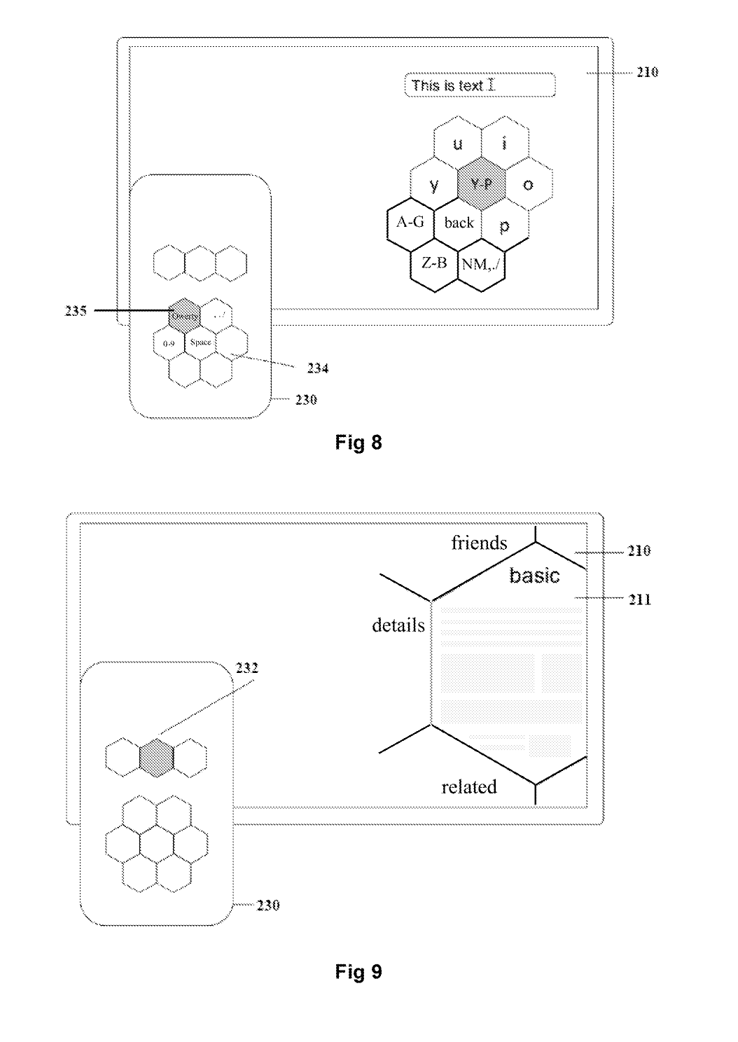

Optionally, as shown in FIG. 9, only some of the options which are available to the user may be displayed on the display 210 once the control key 232 is depressed with the display including input including graphical or other information panels 211.

In a further embodiment of the present invention, movement of the user's hand 300 may be detected without detecting movement of a remote control device. A camera system, such as that used in the Kinect™ system may be utilised, wherein movement of the users hand in a relative orientation corresponding to the relative orientation of the indicia displayed on the screen is detected.

As shown, the camera system 310 may be integral with the screen or alternatively separate to the screen, and in electrical communication with the processor. The camera may be activated through a sequence of gestures, or through using a switch on the display or even through depressing a control switch on a remote control switch to change the mode of the system into gesture mode. Once tracking is initiated, the motion of the hand or some other part of the user may be detected, moving from an initial position toward a further position, such movement being indicative of the spatial relationship between various indicia displayed on the screen of the device.

In still further embodiments, a display screen may not be present (not shown). In these embodiments, the motion of the device or the hand of the user is detected by the system based upon predetermined settings.

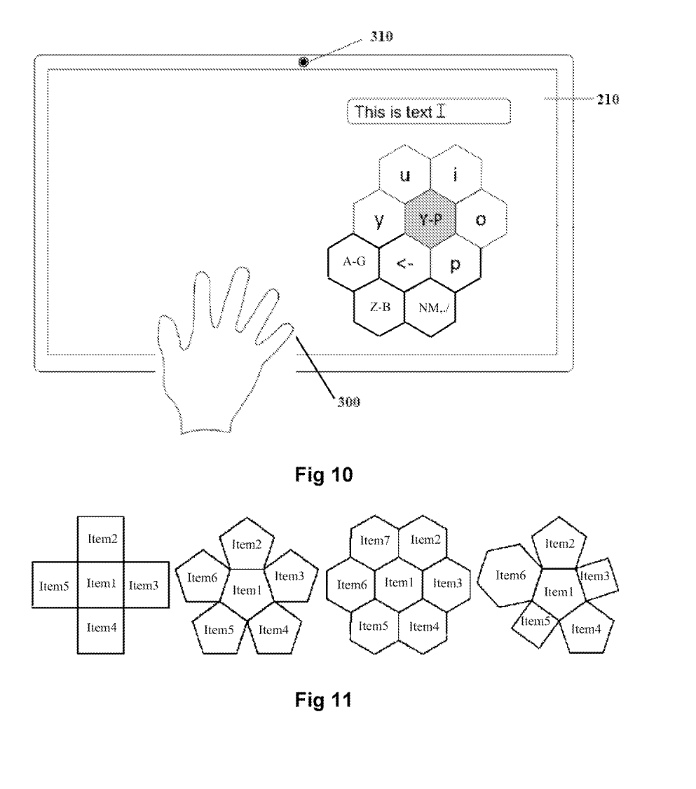

Referring to FIG. 11, there is a shown a representation of the plurality of shapes which may be utilised for display of the indicia. These shapes include squares, pentagons, hexagons, octagons and the like.

A person skilled in the art will appreciate that such shapes are exemplary only, and it is the orientation of the indicia relative to each other that determines the spatial relationship in three dimensional space which is used to select the command corresponding to the selected indicia. Furthermore, the indicia shown may extend circumferentially about the perimeter of the indicia, or may be spaced apart from the indicia.

Furthermore, while the present invention has been explained by reference to the above embodiments, it should be appreciated that the invention can apply, whether with or without modification, to other settings without loss of generality.

1. A system for providing interactions between a processor and an input device by a user for selection of one or more input parameters, said system comprising;
a remote visual display device for displaying a base indicia and a first plurality of indicia spaced apart from the base indicia, wherein said base indicia and said first plurality of indicia are remotely visually identifiable by a user and wherein each of said indicia being indicative of an input parameter;
a user operable selection and input device for remote user selection of an input parameter, said device including a motion detector for detecting motion of the device indicative of the spatial relationship between the base indicia and an indicia of the first plurality of indicia,
wherein a first input parameter is selected upon detection of a first motion of the device indicative of the spatial relationship between the base indicia and a first indicia indicative of said first input parameter, and
a further input parameter is selected upon detection of a further motion of the device indicative of the spatial relationship between the base indicia and a further indicia indicative of said further input parameter.

2. A system according to claim 1 wherein said motion indicative of the spatial relationship between the base indicia and the indicia associated with the remotely selectable input parameters is a displacement.

3. A system according to claim 1 wherein said motion indicative of the spatial relationship between the base indicia and the indicia associated with the remotely selectable input parameters is a rotation.

4. A system according to claim 1 wherein said motion indicative of the spatial relationship between the base indicia and the indicia associated with the remotely selectable input parameters is a displacement in a direction indicative of the spatial relationship of said indicia associated with the remotely selectable input parameters relative to the base indicia.

5. A system according to claim 1 wherein upon detection of said motion by said motion detector, a remotely selectable input parameter is selected.

6. A system according to claim 1 wherein selection of the first remotely selectable input parameter is confirmed by a pre-defined completion action by the user.

7. A system according to claim 6 wherein the pre-defined completion action of the user is selected from the group including activation of a user operable switch of the device, motion of the device in a predetermined direction, motion of the device at a predetermined speed, motion the device at a predetermined acceleration or the like.

8. A system according to claim 1 wherein detection of the motion of the device is initiated upon a pre-determined initiation action by a user.

9. A system according to claim 8 wherein detection of the motion of the device for selection of an input parameter is initiated upon activation of a switch of the device and wherein detection of the motion of the device for selection of the input parameter terminates upon detection of a pre-defined completion action.

10. A system according to claim 1 wherein the first plurality of indicia are arranged at least partly circumferentially about the base indicia.

11. A system according to claim 1 wherein the first plurality of indicia are arranged in a circumferential arrangement about the base indicia.

12. A system according to claim 11 wherein the first plurality of indicia extend from the perimeter of the base indicia.

13. A system according to claim 1 wherein the indicia are selected from the group of shapes including squares, pentagons, hexagons, octagons and the like.

14. A system according to claim 1 wherein said second plurality of indicia displayed are in a pre-determined relationship with the selected indicia of the first plurality of indicia.

15. (canceled)

16. A system according to claim 14 wherein the pre-determined relationship is selected from a group which includes alphabetical proximity, or spatial proximity on a keyboard, alpha numeric grouping, or the like.

17. A system according to claim 1 wherein the device is a hand held remote control device.

18. A system according to claim 1 wherein the motion detector is a gyroscopic sensor configured to produce a signal in response to angular motion relative to one or more reference axes, of the sensor.

19. A system according to claim 17 wherein the hand held remote control device includes a motion detector configured to detect one or more parameters selected from the group including linear acceleration, angular acceleration, velocity, displacement or the like

20. A system according to claim 1 wherein upon selection of a remotely selectable input parameter a change in one or more visual properties of the indicia corresponding to the selected input parameter is displayed on the display device.

21. A system according to claim 1 wherein upon selection of a remotely selectable input parameter, at least one of an audio signal, visual signal or tactile signal is emitted from the user operable selection and input device.

22. A device for selection of one or more input parameters and for providing interaction between a user and a processor of a system including a remote visual display device for displaying a base indicia and a first plurality of indicia spaced apart from the base indicia, wherein said base indicia and said first plurality of indicia are remotely visually identifiable by a user and wherein each of said indicia being indicative of an input parameter, said device including:
a motion detector for detecting motion of the device indicative of the spatial relationship between the base indicia and an indicia of the first plurality of indicia,
wherein a first input parameter is selected upon detection of a first motion of the device indicative of the spatial relationship between the base indicia and a first indicia indicative of said first input parameter, and
a further input parameter is selected upon detection of a further motion of the device indicative of the spatial relationship between the base indicia and a further indicia indicative of said further input parameter.

23. A device according to claim 22 wherein the device is a hand held remote control device.

24. A device according to claim 22 wherein the motion detector is a gyroscopic sensor configured to produce a signal in response to angular motion relative to one or more reference axes, of the sensor.

25. A device according to claim 22 wherein the hand held remote control device includes a motion detector configured to detect one or more parameters selected from the group including linear acceleration, angular acceleration, velocity, displacement or the like

26. A device according to claim 22 wherein upon selection of a remotely selectable input parameter a change in one or more visual properties of the indicia corresponding to the selected input parameter is displayed on the display device.

27. A device according to claim 22 wherein upon selection of a remotely selectable input parameter, at least one of an audio signal, visual signal or tactile signal is emitted from the user operable selection and input device.

28. A system for providing interactions between a processor and a user for selection of one or more input parameters, wherein the input parameters are represented by base position and a first plurality of positions spaced apart from the base position, and wherein the positions are indicative of input parameters, said system comprising;
a user operable selection and input device for remote user selection of an input parameter, said device including a motion detector for detecting motion of the device indicative of the spatial relationship between the base indicia and an indicia of the first plurality of indicia,
wherein a first input parameter is selected upon detection of a first motion by the user indicative of the spatial relationship between the base position and first position of said first input parameter, and
a further input parameter is selected upon detection of a further motion by the user indicative of the spatial relationship between the base position and a further position indicative of said further input parameter.

29. A system according to claim 28 wherein the user operable selection and input device is a hand held device.

30. A system according to claim 28 wherein the user operable selection and input device is a remote motion detection device for detecting motion of the user.

31. A system according to claim 30 wherein the remote detection device is an optical image acquisition system.

32. A system according to claim 28, further including a remote visual display device for displaying a base indicia indicative of said base position, and a first plurality of indicia spaced apart from the base indicia indicative of said first plurality of positions spaced apart from the base position, wherein said base indicia and said first plurality of indicia are remotely visually identifiable by a user and wherein each of said indicia being indicative of an input parameter.

33. A method of providing selection of one or more input parameters by interactions between a processor and an input device by a user in a system comprising a remote visual display device for displaying a base indicia and a first plurality of indicia spaced apart from the base indicia, wherein said base indicia and said first plurality of indicia are remotely visually identifiable by a user and wherein each of said indicia being indicative of an input parameter; and a user operable selection and input device for remote user selection of an input parameter, said device including a motion detector for detecting motion of the device indicative of the spatial relationship between the base indicia and an indicia of the first plurality of indicia said method including the steps of:
(i) selecting a first input parameter by selecting a first indicia of the first plurality of indicia displayed in the visual display device;
(ii) selecting a further input parameter by selecting a further indicia of the first plurality of indicia displayed in the visual display device;
wherein the first indicia is selected by motion of the device by a user indicative of the spatial relationship between the base indicia and the first indicia indicative of said first input parameter, and wherein the further indicia is selected by motion of the device by a user indicative of the spatial relationship between the base indicia and the further indicia indicative of said further input parameter.

34. A method of providing selection of one or more input parameters by interactions between a processor and a user of a system for selection of one or more input parameters, wherein the input parameters are represented by base position and a first plurality of positions spaced apart from the base position, and wherein the positions are indicative of input parameters, wherein the system comprises a user operable selection and input device for remote user selection of an input parameter, said device including a motion detector for detecting motion of the device indicative of the spatial relationship between the base indicia and an indicia of the first plurality of indicia, said method including the steps of:
(i) selecting a first input parameter by movement of a user in a direction of from the base position towards a first position of the first plurality of positions, wherein said movement is detected by said motion detector;
(ii) selecting a further input parameter parameters by movement of the user in a direction of from the base position towards a further position of the first plurality of positions, wherein said movement is detected by said motion detector
wherein the first position is selected by motion of the device by a user indicative of the spatial relationship between the base position and the first position indicative of said first input parameter, and wherein the further position is selected by motion of the user indicative of the spatial relationship between the base position and the further position is a indicative of said further input parameter.
